(19) United States
(12) Patent Application Publication
(10) Pub. No.: US 2010/0053363 A1
(43) Pub. Date: Mar. 4, 2010

(54) PHOTOGRAPHING METHOD AND APPARATUS

(75) Inventor: Kun-sop Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/551,636

(22) Filed: Sep. 1, 2009

(30) Foreign Application Priority Data
Sep. 3, 2008 (KR) 10-2008-0086713

(51) Int. Cl. H04N 5/228; G06K 9/46

(52) U.S. Cl. 348/222.1; 382/195

(57) ABSTRACT

Provided are a photographing method and apparatus for implementing the method. The photographing method includes setting coordinates where a face to be photographed is to be positioned and setting a size of the face, detecting a face from a preview image of a predetermined subject according to the coordinates and the size, and photographing the subject when a face corresponding to the coordinates and the size is detected from the preview image. Thus, coordinates where a face is positioned and a facial size can be adjusted when a user wants to perform a self-photographing operation.

### CROSS-REFERENCE TO RELATED PATENT APPLICATION

This application claims the benefit of Korean Patent Application No. 10-2008-0086713, filed on Sep. 3, 2008, in the Korean Intellectual Property Office, the disclosure of which is incorporated herein in its entirety by reference.

### BACKGROUND

The present invention relates to a photographing method and apparatus, and more particularly, to a self-photographing method and apparatus for a digital camera.

Digital cameras allow pictures to be conveniently taken without incurring additional costs for developing a film. Thus, the general public as well as professional photographers have increasingly used digital cameras to take pictures of various everyday things. In addition, self-photographing using digital cameras has remarkably increased over self-photographing using film cameras.

Since a lens for capturing a subject image is disposed at a front portion of a camera, a user manipulates the camera so that the lens is directed pointed at him or herself when performing a self-photographing operation. Unlike in the general case where other people or objects are photographed, it is difficult to correctly perform a self-photographing operation since a user cannot check his or her own figure or face that is to be photographed, when performing a self-photographing operation.

Generally, since a display unit such as a liquid crystal display (LCD) window is installed on a digital cameral, a subject to be photographed is displayed on the LCD window, and thus photographing can be conveniently performed. Recently, digital cameras have been developed so that an installation angle of an LCD window can be changed, thereby improving convenience when performing a self-photographing operation. That is, by rotatably installing the LCD window, which is disposed on a surface opposite to a lens, in a main body of a digital camera, a user can perform self-photographing by rotating the LCD window and checking his or her own figure or face in the LCD window. Various other technologies are used to support self-photographing in digital cameras, in addition to the technology in which an LCD window is rotatably installed in a main body. For example, a barrel including a lens may be rotatably installed in a main body of a digital camera.

However, in a digital camera in which an LCD window or a barrel is rotatably installed, the thickness of the digital camera is increased and additional components need to be installed in a main body of the digital camera.

In addition, digital cameras such as compact cameras have been developed to have a wide angle. Thus, when performing self-photographing, 80% of a screen is occupied by a user's face in a general camera, but 25% of a screen is occupied by the user's face in a wide angle camera. That is, since a ratio of a background is also increased when performing self-photographing, it is important to arrange the background and a user's face. Thus, in conventional self-photographing technologies, it is most important that a user's facial image is positioned at the center and is photographed rather than being cut off. However, recently, there is a need for a self-photographing guidance that can help a user on performing self-photographing with accuracy and desired arrangement of the face and the background.

### SUMMARY

Various embodiments of the present invention provide a photographing method and apparatus in which coordinates where a face is positioned and a facial size are adjusted, and guidance for desired coordinates and facial size is provided for a self-photographing operation.

Various embodiments of the present invention also provide a photographing method and apparatus in which desired coordinates and facial size are determined and then photographing can be performed when a user's face is a smiling face.

According to an aspect of the present invention, there is provided a photographing method including setting coordinates where a face to be photographed is to be positioned and setting a size of the face; detecting a face from a preview image of a predetermined subject according to the set coordinates and size; and photographing the subject when a face corresponding to the set coordinates and size is detected from the preview image.

The photographing may further include determining whether the detected face is a smiling face, and the subject may be photographed when the detected face is a smiling face.

The detecting may further include notifying a user of non-detection information when the face corresponding to the set coordinates and size is not detected from the preview image.

The non-detection information may include information for guiding a difference in coordinates and/or facial size between the set face and the face detected by the preview image.

The notification may be performed using one of a beep tone, a voice and a directional indication of a light emitting diode (LED).

The photographing method may further include notifying a user of expression-determining information when the detected face is not a smiling face.

The photographing method may further include notifying a user that preparation for photographing is completed when the face corresponding to the set coordinates and size is detected from the preview image.

The photographing method may further, prior to the setting, include selecting a self-photographing mode, wherein the selecting is performed by a user.

The set coordinates and size may be set by a user's input.

According to another aspect of the present invention, there is provided a photographing method including setting coordinates where a face to be photographed is to be positioned and setting a size of the face, wherein the setting is performed by a user's input; detecting a face from a preview image of a predetermined subject according to the set coordinates and size; determining whether an expression of the face is a smiling expression when a face corresponding to the coordinates and the size is detected from the preview image; and photographing the subject when the face is determined to be a smiling face.

The detecting may further include notifying a user of non-detection information when the face corresponding to the set coordinates and size is not detected from the preview image.

The photographing method may further include notifying a user of expression-determining information when the detected face is not a smiling face.

According to an aspect of the present invention, there is provided a computer readable recording medium having recorded thereon a program for executing the above method.

According to another aspect of the present invention, there is provided a photographing apparatus including a coordinate setting unit setting coordinates where a face to be photographed is to be positioned; a size setting unit setting a size of the face; a detector detecting a face from a preview image of a predetermined subject according to the set coordinates and size; and a controller controlling photographing of the subject when the face detector detects a face corresponding to the set coordinates and size from the preview image.

The photographing apparatus may further include an expression determining unit determining whether the detected face is a smiling face, wherein the controller controlling photographing of the subject when expression determining unit determines that the detected face is a smiling face.

The photographing apparatus may further include a notification controller notifying a user about non-detection information when the face detector does not detect the face corresponding to the set coordinates and size from the preview image.

The non-detection information may include information for guiding a difference in at least one of the coordinates and facial size between the set face and the face detected by the preview image.

The notification controller may notify a user that preparation for photographing is completed when the face corresponding to the set coordinates and size is detected from the preview image.

The notification controller may notify the user of expression determining information when the expression of the face is not a smile expression.

The coordinates and the size may be set by a user's input.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital photographing apparatus according to an embodiment of the present invention;

FIG. 2 is a block diagram of a digital signal processor (DSP) illustrated in FIG. 1;

FIG. 3 is a block diagram of a DSP, according to another embodiment of the present invention;

FIGS. 4A and 4B are pictorial diagrams illustrating settings of coordinates and size, according to another embodiment of the present invention;

FIGS. 5A and 5B are pictorial diagrams illustrating detection of a face corresponding to set coordinates and size, according to an embodiment of the present invention;

FIGS. 6A and 6B are pictorial diagrams illustrating the case where it is determined whether a detected face is a smiling face, according to an embodiment of the present invention;

FIG. 7 is a flow chart of a photographing method according to an embodiment of the present invention; and

FIG. 8 is a flow chart of a photographing method according to another embodiment of the present invention.

### DETAILED DESCRIPTION OF THE EMBODIMENTS

Hereinafter, the present invention will be described in detail by explaining exemplary embodiments of the invention with reference to the attached drawings. While describing the present invention, detailed descriptions about related well-known functions or configurations that may diminish the clarity of the points of the present invention may be omitted.

Also, since later-described terms are defined in consideration of the functions of the present invention, they may vary according to users' intentions or practice. Hence, the terms must be interpreted based on the contents of the entire specification.

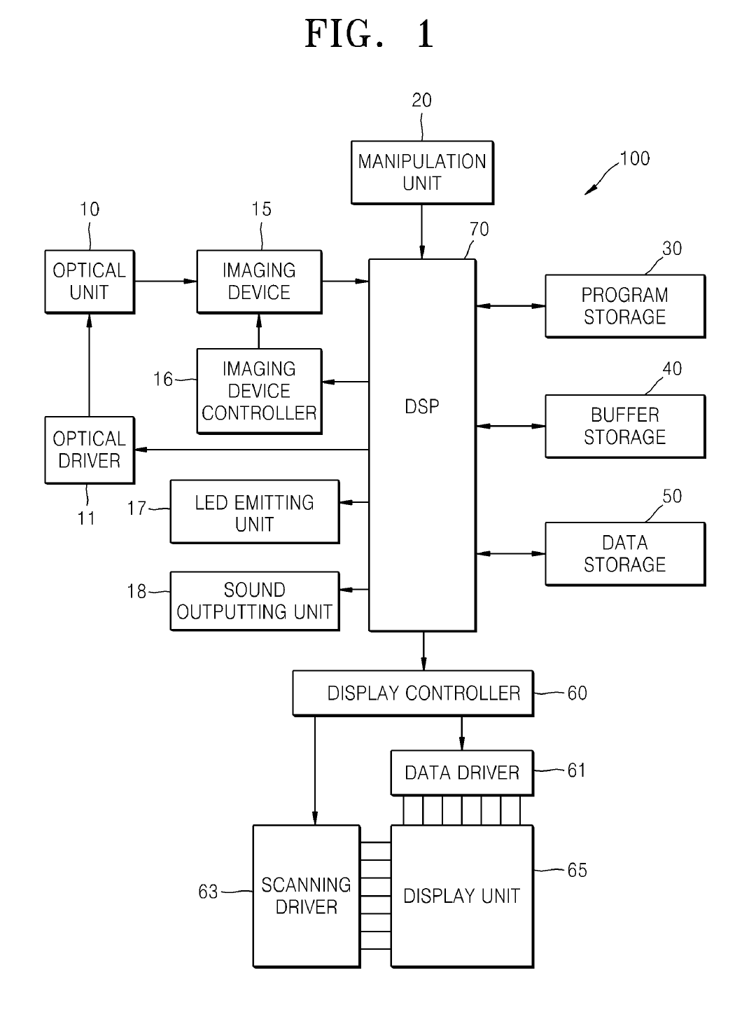

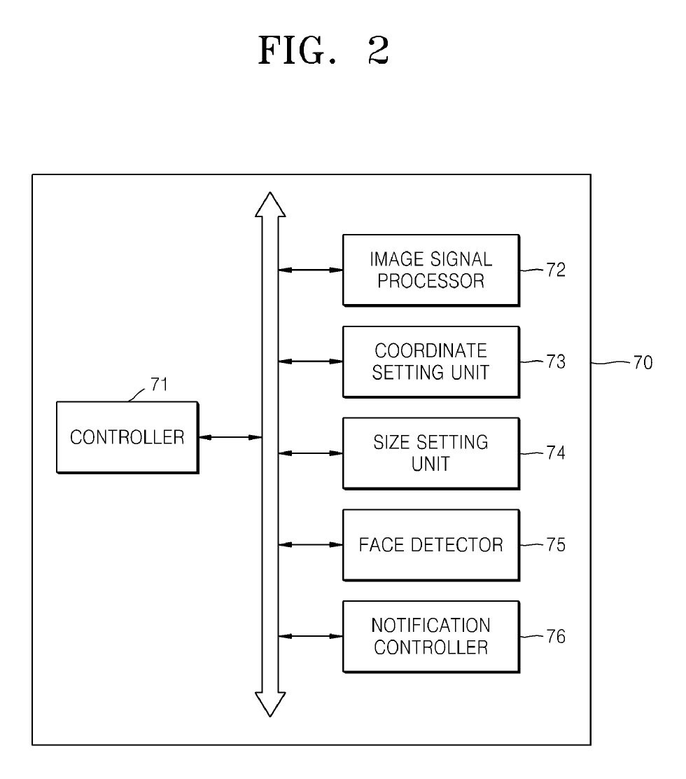

FIG. 1 is a block diagram of a digital photographing apparatus 100 according to an embodiment of the present invention. FIG. 2 is a block diagram of a digital signal processor (DSP) 70 illustrated in FIG. 1.

Referring to FIG. 1, the digital photographing apparatus 100 may be a digital cameral and may include an optical unit 10, an optical driver 11, an imaging device 15, an imaging device controller 16, a light emitting diode (LED) emitting unit 17, a sound outputting unit 18, a manipulation unit 20, a program storage 30, a buffer storage 40, a data storage 50, a display controller 60, a data driver 61, a scanning driver 63, a display unit 65, and a DSP 70.

The optical unit 10 receives an optical signal corresponding to a subject and provides the optical signal to the imaging device 15. The optical unit 10 may include one or more lenses, such as a zoom lens that controls a viewing angle to be narrow or wide according to a focal length, and a focus lens that focuses on the subject. Also, the optical unit 10 may include an iris that controls an amount of light.

The optical driver 11 controls positions of the lenses and opening of the iris. The subject may be focused on by moving the positions of the lenses. Also, the amount of light may be controlled by controlling the opening of the iris. The optical driver 11 may control the optical unit 10 according to a control signal that is automatically generated due to a real-time-input image signal or a control signal that is manually input by user manipulation.

The optical signal passed through the optical unit 10 reaches a light-receiving surface of the imaging device 15 so as to form an image of the subject. The imaging device 15 is a photoelectric conversion device, such as a charge coupled device (CCD) or a complementary metal oxide semiconductor image sensor (CIS), which converts an optical signal into an electric signal. The imaging device 15 may be controlled by the imaging device controller 16 in that, for example, the speed of the imaging device 15 may be controlled by the imaging device controller 16. The imaging device controller 16 may also control the imaging device 15 according to a control signal that is automatically generated due to a real-time-input image signal or a control signal that is manually input by user manipulation.

The LED emitting unit 17 turns on an LED installed on an external surface of a digital camera according to the control of the digital signal processor 70. In an exemplary embodiment of the present invention, the LED emitting unit 17 may indicate information regarding guidance of self-photographing or information indicating that the preparation for photographing is completed.

The sound outputting unit 18 outputs an operation acknowledgement tone or voice according to the control of the digital signal processor 70. In an exemplary embodiment of the present invention, the sound outputting unit 18 outputs a beep tone or a voice message in order to guide the self-photographing operation.

The manipulation unit 20 may input a control signal from the outside, for example, from the user. In an exemplary embodiment of the present invention, a user can set the coordinates and size of his or her facial image to be positioned on a screen through the manipulation unit 20. In addition, a user selects a self-photographing mode by using the manipulation unit 20, and then performs the self-photographing operation.

The manipulation unit 20 includes various function buttons such as a shutter release button for taking a photograph by exposing the imaging device 15 to light for a predetermined period of time, a power button for supplying power, wide-angle and telephoto zoom buttons for widening or narrowing the viewing angle according to user input, text input buttons, a mode selection button for selecting a photographing mode or a reproducing mode, and setting buttons for setting white balance and exposure. The manipulation unit 20 may include the various buttons as described above but the present invention is not limited thereto. The manipulation unit 20 may be implemented in any form, such as a keyboard, a touch pad, or a remote controller, through which the user may input signals.

The digital photographing apparatus 100 includes the program storage 30 for storing programs such as an operating system and an application system, which drive the digital photographing apparatus 100, the buffer storage 40 that temporarily stores data necessary for performing operations and result data of the operations, and the data storage 50 that stores various types of data necessary for the programs.

Also, the digital photographing apparatus 100 includes the display controller 60 that controls displaying of an operation state of the digital photographing apparatus 100 and image data captured by the digital photographing apparatus 100, the data driver 61 and the scanning driver 63 which receive and transfer display data from the display controller 60, and the display unit 65 that displays a predetermined image according to signals input from the data driver 61 and the scanning driver 63. The display unit 65 may be formed of, for example, a liquid crystal display (LCD) panel, an organic light-emitting diode (OLED) panel, or an electrophoresis display (EDD) panel.

In addition, the digital photographing apparatus 100 includes the DSP 70 that processes image signals input to the digital photographing apparatus 100 and controls other elements according to the image signals or external input signals.

The DSP 70 will now be described in detail with reference to FIG. 2.

Referring to FIG. 2, the DSP includes a controller 71, an image signal processor 72, a coordinate setting unit 73, a size setting unit 74, a face detector 75 and a notification controller 76.

The coordinate setting unit 73 sets coordinates of a facial image to be positioned on a screen. When a user determines a desired location of his or her facial image to be self-photographed, on the screen by using the manipulation unit 20 illustrated in FIG. 1, the coordinate setting unit 73 sets coordinates corresponding to the location.

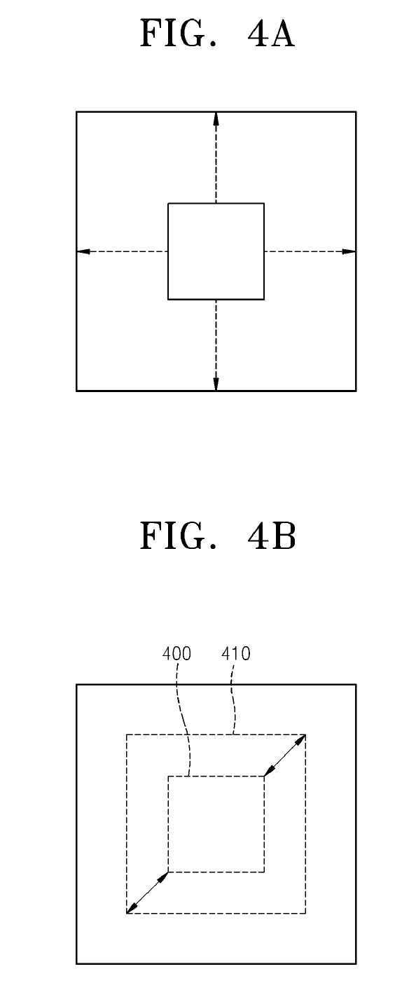

FIG. 4A illustrates a screen on which a user selects a location of a face that is to be photographed by moving a window in horizontal and vertical directions, according to an embodiment of the present invention. In FIG. 4A, a square window is used. Alternatively, the location of the face can be selected by moving a predetermined figure or a spot by manipulating a directional button or a joystick type button.

The size setting unit 74 sets a facial size regarding a face to be photographed. Like in the coordinate setting unit 73, when a user selects a desired facial size, to be self-photographed, though the manipulation unit 20 illustrated in FIG. 1, the size setting unit 74 sets a facial size corresponding to the desired facial size. In this case, the facial size may be set after a user selects the location of the face, or alternatively, only the facial size may be selected while the location of the face is fixed, for example, the coordinates of the facial image are fixed at the center.

FIG. 4B illustrates a display screen on which a user expands a square window 400 set by the coordinate setting unit 73 to a square window 410, according to an embodiment of the present invention. A user can adjust a facial size by increasing or reducing the size of the square window 400 by using a directional button or a joystick type button.

The face detector 75 detects a facial image from a preview image of a subject to be photographed according to the coordinates set by the coordinate setting unit 73 and the facial size set by the size setting unit 74. There are many face detection techniques and algorithms, any one of which may be used to detect a facial image according to an exemplary embodiment of the present invention. For example, the face may be detected by using a motion vector algorithm, a feature point detection algorithm, or an Adaboost learning algorithm. When the facial size is detected, a face region can be detected based on colors or edges. Generally, since a person regards a face as a region including a head portion, the facial size may be calculated by detecting the region including the head portion based on colors or edges, calculating the number of pixels of the region and then calculating a ratio of the region with respect to an entire screen.

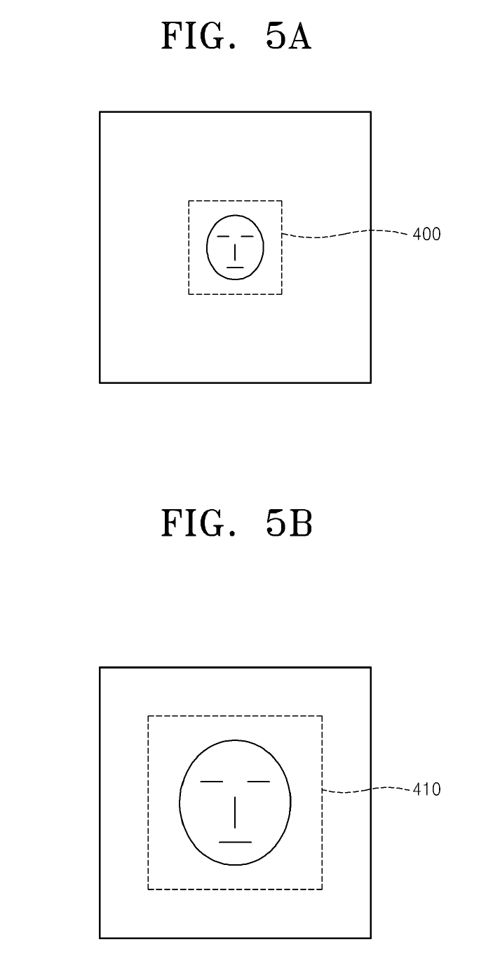

FIGS. 5A and 5B illustrate the cases where a face is detected on a preview image according to the coordinates and the facial size set by a user, according to embodiments of the present invention. FIG. 5A illustrates the case where the facial image is detected when a facial size is set to a small size, that is, the size of the square window 400. FIG. 5B illustrates the case where the facial image is detected when the facial size is set to a big size, that is, the size of the square window 410. When a user sets a predetermined facial size, the predetermined facial size may be accurately detected, or alternatively the predetermined facial size may be detected to within a predetermined tolerance.

The notification controller 76 controls a pertaining element to notify a user of non-detection information or completion of the preparation for photographing. The notification controller 76 notifies the user of the non-detection information indicating that a face is not detected when the face detector 75 cannot detect a face having the set coordinates and facial size from the preview image. This notification is performed by a beep tone, a voice or LED indication. In addition, the non-detection information is used to guide the user, and includes information regarding a difference in coordinates and/or facial size between a facial image of user's settings and a facial image detected from the preview image by the face detector 75, for example, information regarding a difference in coordinates between the facial image detected from the preview and the image of the user's settings, which is measured in horizontal and vertical directions, or information regarding a difference in facial size between the facial image detected from the preview and the image of the user's settings.

In addition, when the face detector 75 detects a facial image having the set coordinates and facial size from the preview, the notification controller 76 may notify the user that the preparation corresponding to the set coordinates and facial size is completed by generating a beep tone or a voice message such as “preparation for self-photographing is completed”, or by using an LED flash indication. Other methods as well as these methods may be used to notify the user. Thus, when the user is notified that the preparation for self-photographing is completed, the user can successfully perform the self-photographing operation by pressing a shutter release button.

The controller 71 controls an overall operation of the DSP 70. In addition, the controller 71 controls the DSP 70 to photograph a subject when the face detector 75 detects the face corresponding to the set coordinates and facial size. In addition, the controller 71 also controls the DSP 70 to photograph the subject when the face detector 75 accurately detects the face having the set coordinates and size as well as detects the face within a predetermined tolerance. In addition, the controller 71 may control the DSP 70 to photograph the subject without pressing a shutter release button when the face detector 75 detects the face.

The image signal processor 72 converts an image signal input from the imaging device 15 to a digital signal, and performs image-signal processing such as gamma correction, color filer array interpolation, color matrix, color correction, color enhancement, etc., in order to convert to the image signal so as to be suitable for human vision. The image signal processor 72 may perform an auto white balance or auto exposure algorithm if such a function is set. In addition, the image signal processor 72 forms a predetermined type image file by adjusting the size of image data by using a scaler and compressing the image data. On the other hand, the image signal processor 72 may decompress the image file. The image signal processor 72 may perform the above image-signal processing with respect to an image signal which is input in real time in a preview mode prior to photographing and an image signal which is input by a shutter-release signal. At this time, other image-signal processing may be performed with respect to these image signals.

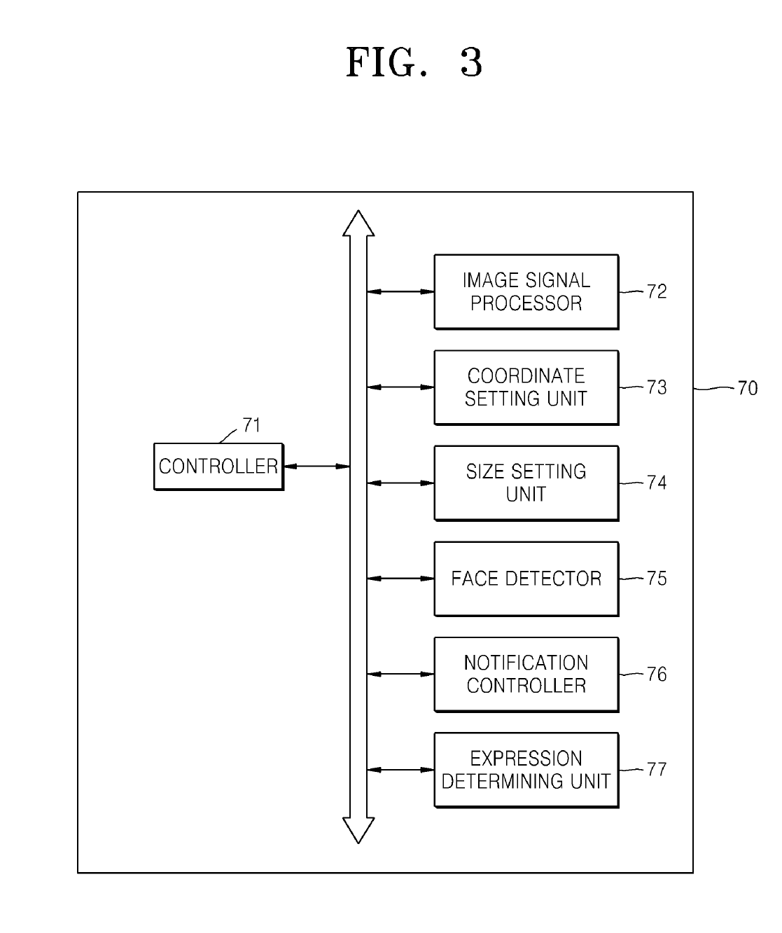

FIG. 3 is a block diagram of a DSP 70, according to another embodiment of the present invention.

Referring to FIG. 3, the DSP 70 includes a controller 71, an image signal processor 72, a coordinate setting unit 73, a size setting unit 74, a face detector 75, a notification controller 76 and an expression determining unit 77. The DSP 70 of FIG. 3 is different from the DSP 70 of FIG. 2 in that the DSP 70 of FIG. 3 further includes the expression determining unit 77. The DSP 70 will be described in terms of the expression determining unit 77.

When the face detector 75 accurately detects a face having coordinates and size as set by a user, as well as detects the face within a predetermined tolerance, the expression determining unit 77 determines whether the face is a smiling face. Whether the face is a smiling face may be determined by previously storing general properties of the smiling face, such as raised eyebrows or mouth corners, and then comparing the stored properties with detected properties. Alternatively, whether the face is the smiling face may be determined by comparing the stored properties with the detected properties and then numerically expressing the comparison value. In this case, the face may be determined to be the smiling face when the comparison value is equal to or greater than a predetermined threshold value.

The controller 71 may control the DSP 70 to photograph the face without pressing a shutter release button when the expression determining unit 77 determines the face is the smiling face. In addition, the notification controller 76 may notify the user of expression determining information by using a voice message such as “smile” when the expression determining unit 77 determines the face is not the smiling face.

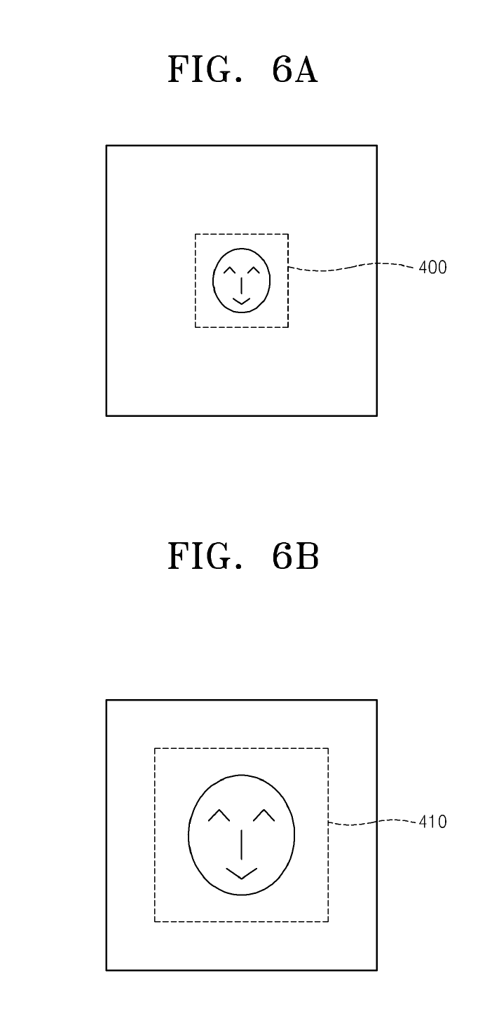

Referring to FIGS. 6A and 6B, the expression determination unit 77 determines whether the face is a smiling face, and thus the user can perform the self-photographing operation on a smiling face, which also has the desired coordinates and size.

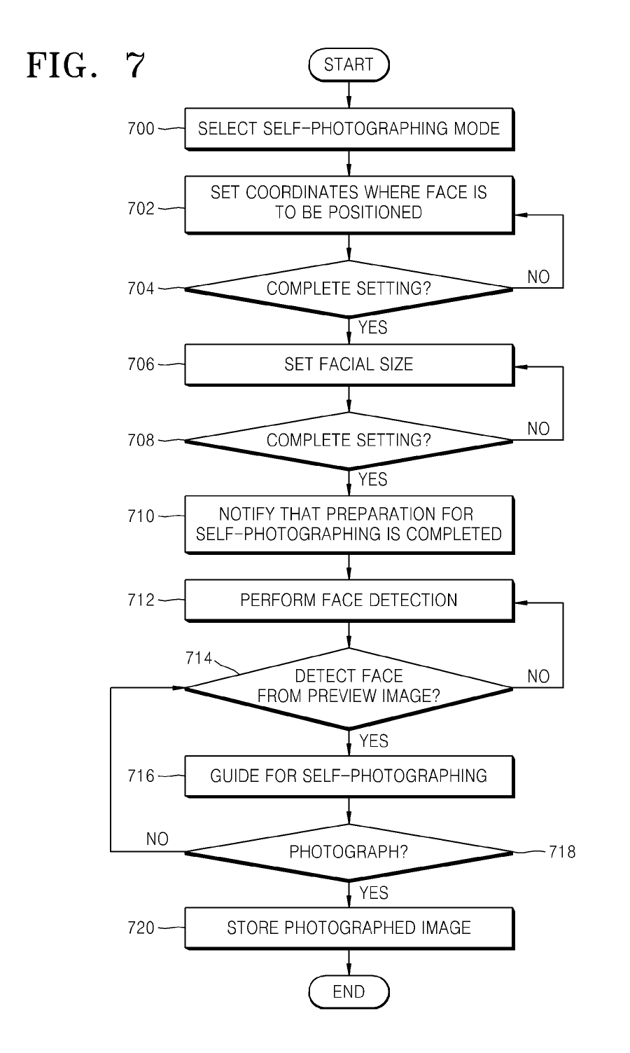

FIG. 7 is a flow chart of a photographing method according to an embodiment of the present invention.

Referring to FIG. 7, in operation 700, a user selects a self-photographing mode. In operation 702, coordinates where a face to be photographed is positioned are set. When setting of the coordinates is completed in operation 704, a facial size is set in operation 706. When settings of the facial size are completed in operation 708, a user is notified that the preparation for self-photographing is completed 710. Then, a user positions his or her face in front of a lens of a camera. In operation 712, face detection is performed. In operation 714, it is determined whether the face is detected from a preview image. When the face is not detected, operation 712 proceeds to perform the face detection. When the face is detected, operation 716 proceeds to guide the self-photographing operation. When the face is detected so as to correspond to the coordinates and facial size, as set by the user, or to be within a predetermined tolerance, the user is notified that the preparation for self-photographing is completed. When the face is detected as not corresponding to the coordinates and facial size set by the user, the user may be notified of the degree of difference. Thus, the user can adjust the camera according to the self-photographing guidance. In operation 718, the self-photographing operation is performed when a shutter release button is pressed by the user. In addition, when the shutter release button is not pressed within a predetermined period of time, operation 714 proceeds to detect whether the face is detected. In operation 720, the captured image is stored.

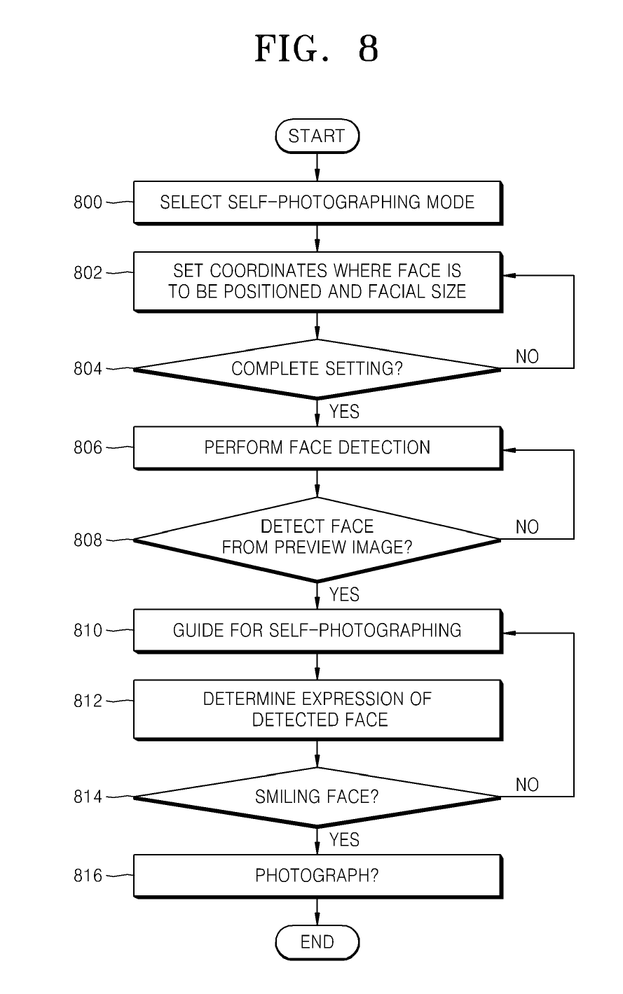

FIG. 8 is flow chart of a photographing method according to another embodiment of the present invention.

Referring to FIG. 8, in operation 800, a user selects a self-photographing mode. In operation 802, coordinates where a face to be photographed is positioned and a facial size are set. In operation 804, when the setting is completed, operation 806 proceeds to detect the face. In operation 808, it is determined whether the face is detected from a preview image. When the face is not detected, operation 806 proceeds to detect the face. When the face is detected, operation 810 proceeds to perform self-photographing guidance. When the face is detected so as to correspond to the coordinates and facial size, as set by the user, or to be within a predetermined tolerance, the user is notified that the preparation for self-photographing is completed. When the face is detected as not corresponding to the coordinates and facial size set by the user, the user may be notified of the degree of difference. Thus, the user can adjust the camera according to a self-photographing guidance. In operation 812, an expression of the detected face is determined. In operation 814, when the detected face is determined to be a smiling face, operation 816 proceeds to perform the self-photographing operation. In operation 814, when the face is determined to be a non-smiling face, operation 810 proceeds to perform the self-photographing guidance. In this case, the user is notified of the expression determining information.

Although the above embodiments of the present invention are described based on a digital camera as an example of a digital photographing apparatus, the present invention is not limited thereto. It will be understood by one of ordinary skill in the art that the present invention may be applied to mobile phones having camera functions, personal digital assistants (PDAs), and portable multimedia players (PMPs).

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A photographing method comprising:
setting coordinates where a face to be photographed is to be positioned and setting a size of the face;
detecting a face from a preview image of a predetermined subject according to the set coordinates and size; and
photographing the subject when a face corresponding to the set coordinates and size is detected from the preview image.

2. The photographing method of claim 1, wherein the photographing further comprises:
determining whether the detected face is a smiling face, and wherein the subject is photographed when the detected face is a smiling face.

3. The photographing method of claim 1, wherein the detecting further comprises notifying a user of non-detection information when the face corresponding to the set coordinates and size is not detected from the preview image.

4. The photographing method of claim 3, wherein the non-detection information comprises information for guiding a difference in at least one of coordinates and facial size between the set face and the face detected by the preview image.

5. The photographing method of claim 3, wherein the notification is performed using one of a beep tone, a voice and a directional indication of a light emitting diode (LED).

6. The photographing method of claim 2, further comprising notifying a user of expression determining information when the detected face is not a smiling face.

7. The photographing method of claim 2, further comprising notifying a user that preparation for photographing is completed when the face corresponding to the set coordinates and size is detected from the preview image.

8. The photographing method of claim 1, further comprising, prior to the setting:
selecting a self-photographing mode, wherein the selecting is performed by a user.

9. The photographing method of claim 1, wherein the set coordinates and size are set by a user's input.

10. A photographing method comprising:
setting coordinates where a face to be photographed is to be positioned and a size of the face, wherein the setting is performed by a user's input;
detecting a face from a preview image of a predetermined subject according to the set coordinates and size;
determining whether an expression of the face is a smiling expression when a face corresponding to the coordinates and the size is detected from the preview image; and
photographing the subject when the face is determined to be a smiling face.

11. The photographing method of claim 10, wherein the detecting further comprises notifying a user of non-detection information when the face corresponding to the set coordinates and size is not detected from the preview image.

12. The photographing method of claim 10, further comprising notifying a user of expression determining information when the detected face is not a smiling face.

13. A computer readable recording medium having recorded thereon computer readable program code comprising a program for executing a photographing method, comprising:
setting coordinates where a face to be photographed is to be positioned and setting a size of the face;
detecting a face from a preview image of a predetermined subject according to the set coordinates and size; and
photographing the subject when a face corresponding to the set coordinates and size is detected from the preview image.

14. A photographing apparatus comprising:
a coordinate setting unit for setting coordinates where a face to be photographed is to be positioned;
a size setting unit for setting a size of the face;
a detector for detecting a face from a preview image of a predetermined subject according to the set coordinates and size; and
a controller for controlling photographing of the subject when the face detector detects a face corresponding to the set coordinates and size from the preview image.

15. The photographing apparatus of claim 14, further comprising an expression determining unit for determining whether the detected face is a smiling face,
wherein the controller controls photographing of the subject when expression determining unit determines that the detected face is a smiling face.

16. The photographing apparatus of claim 15, further comprising a notification controller for notifying a user about non-detection information when the face detector does not detect the face corresponding to the set coordinates and size from the preview image.

17. The photographing apparatus of claim 16, wherein the non-detection information comprises information for guiding a difference in at least one of the coordinates and facial size between the set face and the face detected by the preview image.

18. The photographing apparatus of claim 16, wherein the notification controller notifies a user that preparation for photographing is completed when the face corresponding to the set coordinates and size is detected from the preview image.

19. The photographing apparatus of claim 16, wherein the notification controller notifies the user of expression-determining information when the expression of the face is not a smile expression.

20. The photographing apparatus of claim 16, wherein the coordinates and the size are set by a user's input.
